(19) United States
(12) Patent Application Publication
(10) Pub. No.: US 2010/0048193 A1
(43) Pub. Date: Feb. 25, 2010

(54) SECURE UPGRADE OF A MOBILE DEVICE WITH AN INDIVIDUAL UPGRADE SOFTWARE OVER THE AIR

(76) Inventors: Jean-Michel Ortion, St Gervais en Belin (FR); Michel Catrouillet, Le Mans (FR)

Correspondence Address: HOGAN & HARTSON LLP, ONE TABOR CENTER, SUITE 1500, 1200 SEVENTEENTH ST, DENVER, CO, 80202, US

(21) Appl. No.: 12/373,661

(22) PCT Filed: Jul. 4, 2007
(86) PCT No.: PCT/IB07/52621

§ 371 Date: Oct. 8, 2009

(30) Foreign Application Priority Data
Jul. 13, 2006 (EP) 06300806.4

(51) Int. Cl. H04M 3/00

(52) U.S. Cl. 455/418

(57) ABSTRACT

The invention concerns a method for securely upgrading a mobile device with an individual upgrade software, the individual upgrade software remaining unusable by a mobile device as long as the individual upgrade software has not been activated. The method includes transmitting its unique identification number to the mobile device management apparatus; calculating a mobile device encryption identity and a management apparatus encryption identity; transmitting only the individual upgrade software and the calculated management apparatus encryption identity; the mobile device calculating an activation encryption identity and an activation decryption identity; comparing the calculated activation decryption identity to the activation encryption identity; and activating the individual upgrade software for use by the mobile device as a result of a positive comparison.

### FIELD OF THE INVENTION

The invention relates to securely upgrading a mobile device belonging to a plurality of mobile devices with an individual upgrade software over the air, the individual upgrade software remaining unusable by a mobile device as long as the individual upgrade software has not been activated.

### BACKGROUND OF THE INVENTION

Mobile telephone network operators and mobile device manufacturers continually add security features to mobile devices to prevent the hacking and copying of software that implements certain functionalities or applications reserved for top of the range mobile devices. The software generally implements options and services that are exclusive to fully featured mobile devices. The software is subsequently copied to a mobile device of restricted functionality to increase the number of available applications on the mobile device. This results in a violation of intellectual property rights and in lost revenue by mobile device vendors and mobile telephone network operators.

While mobile telephone network operators and mobile device manufacturers need to actively protect the software content of mobile devices, they simultaneously need to be able to update or upgrade over the air the software content of their mobile devices that have already been launched onto the market. The update of software or firmware in devices over the air is used to correct errors or problems with existing code resident in the device, add new features or functionality and to modify resident applications.

The update of software or firmware in devices over the air is currently achieved using the open mobile alliance device management (OMA-DM) specifications. However, OMA-DM only allows software or firmware upgrades that are generic to a device model. Thus firmware upgrades are identical for each mobile device belonging to a group of mobile devices that are of the same model.

This is unsatisfactory for mobile device vendors and mobile telephone network operators who need to be able to update or upgrade over the air the software of individual and targeted mobile devices. This allows individual device problems to be treated, allows services and applications to be proposed to individual clients over the air and distinguishes the client allowing a loyal clientele base to be built.

U.S. Pat. No. 6,832,373 describes a system for updating a plurality of distributed electronic devices with an update package. An update server receives information related to the model of the electronic device and the version of software currently used by the electronic device and the update server subsequently transfers an available generic update package to the electronic device. The update package is encrypted during transmission and executed by the electronic device following decryption and a verification that no errors have occurred during transmission. However, the copying of the update package from this electronic device and execution on another electronic device is not prevented and an individual mobile device cannot be specifically targeted with an update package.

There thus exists a need to be able to individually upgrade the software of a mobile device while simultaneously providing adequate protection of this software contained in the mobile device from external intrusion and hacking.

### OBJECT AND SUMMARY OF THE INVENTION

It is an object of the present invention to provide a method for securely upgrading a mobile device belonging to a plurality of mobile devices with an individual upgrade software according to claim 1.

Other features of the interface device are found in the dependent claims.

### BRIEF DESCRIPTION OF THE DRAWINGS

The above object, features and other advantages of the present invention will be best understood from the following detailed description in conjunction with the accompanying drawings, in which:

FIG. 1 is a schematic block diagram of a system for securely upgrading a mobile device belonging to a plurality of mobile devices with an individual upgrade software; and

FIG. 2 is a flow chart of a method for securely upgrading a mobile device belonging to a plurality of mobile devices with an individual upgrade software.

In the drawings, the same reference numbers are used to designate the same elements.

### DESCRIPTION OF EMBODIMENTS

The method for securely upgrading a mobile device belonging to a plurality of mobile devices with an individual upgrade software according to the invention is suited for use with any device management server, central unit or base station that communicates over the air with a plurality of mobile devices to perform remote management or device configuration for example. The method is suitable for use with any mobile device such as a mobile phone, a personal digital assistant (PDA) or any device connected to a network through transport protocols such as for example hyper text transfer protocol (HTTP), wireless application protocol (WAP) or object exchange protocol (OBEX).

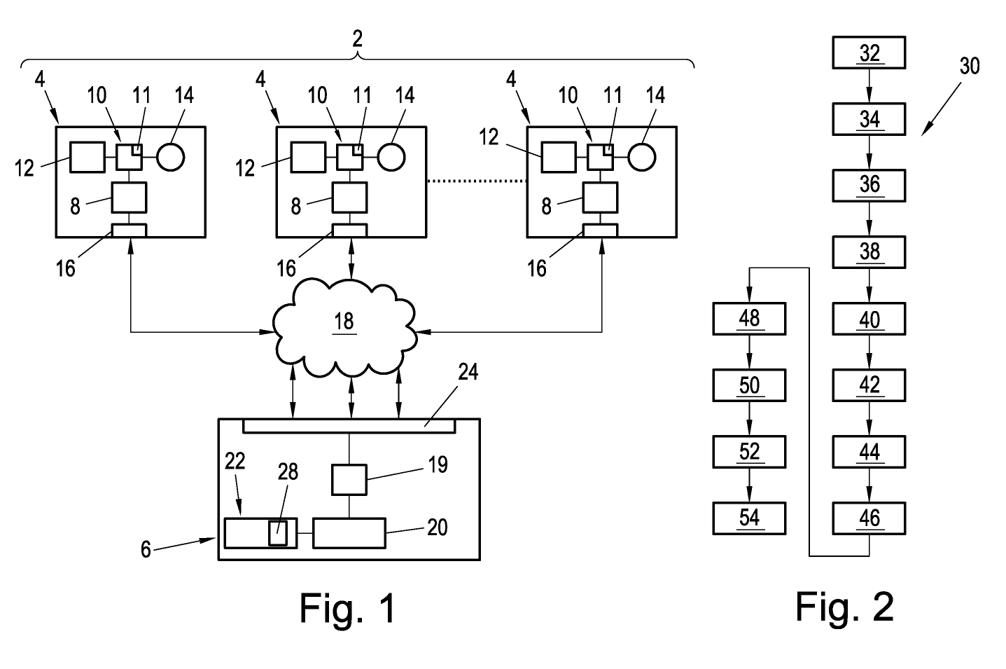

FIG. 1 illustrates a schematic block diagram of a system 2 for securely upgrading a mobile device 4 belonging to a plurality of mobile devices with an individual upgrade software according to the invention.

The system 2 comprises a plurality of mobile devices 4 and a mobile device management apparatus 6. The device 4 in the current embodiment is for example a mobile telephone and the mobile device management apparatus 6 is a centralised server in communication over the air using radio frequency communication with the network of mobile devices and the mobile device management apparatus 6 carries out centralised mobile device management using the open mobile alliance device management specifications.

The system 2 includes a pair of cryptographic keys (one public key and one private key) used by asymmetric key cryptography RSA. The public key is stored in mobile device 4. The private key is stored securely in apparatus 6. This key pair may be owned either by a network operator or by the mobile manufacturer.

Each mobile device 4 contains a device processor 8 containing a unique identification number that uniquely discriminates and individually identifies this mobile device 4 from any other mobile device 4 of the system 2, a storage unit 10 containing device operation software 11, a decryption processor 12, a mobile device encryption processor 14 and a device communication interface 16 adapted to communicate over the air with the mobile device management apparatus 6.

The device processor 8 is an integrated electronic circuit comprising semiconductor electronic devices fabricated on a substrate of semiconductor material. The device processor 8 is adapted to control the storage unit 10, the decryption processor 12, the mobile device encryption processor 14 and the device communication interface 16 as well as communication between these mobile device components. The device processor 8 also communicates over the air with the mobile device management apparatus 6 through the communication interface 16.

The device processor 8 contains a programmable read-only memory (PROM) or One Time Programmable (OTP) memory that contains a unique identification number. The unique identification number has at least 128 bits and is permanently written during fabrication of the device processor 8. The unique identification number contains an identifier for the fabrication factory, the lot number, the wafer number and the position of the processor on the wafer. The unique identification number is not modifiable or erasable and can be read using device operation software 11 at a predetermined register address. Each device processor 8 in each mobile device 4 contains a different unique identification number and no two device processor 8 have the same unique identification number. The PROM (or OTP) also contains an RSA public key. This public key is stored in the PROM at the production of the mobile device. This public key is identical for all the mobiles devices 4. The key length will be at least 1024 bits.

The storage unit 10 is a non-volatile flash memory containing the device operation software 11 that is executed by the device processor 8 each time the mobile device is powered-up/turned on. The device operation software 11 contains instructions that activate the mobile device applications, functionalities and services so that the mobile device is ready for use. The device operation software additionally sets up communication with the communications network 18 and manages communication between the mobile device 4 and the mobile device management apparatus 6.

The device communication interface 16 comprises a receiver-transmitter capable of communication using radio frequencies. The decryption processor 12 is adapted to implement a cryptography algorithm. In the current embodiment an RSA public-key encryption algorithm is employed. The RSA public-key encryption algorithm is well known and will not be described in detail. Further details can be found in the following reference: PKCS #1: RSA Cryptography Standard available at http://www.rsasecurity.com. The mobile device encryption processor 14 is adapted to calculate a keyed hash function and in the current embodiment a keyed secure hash algorithm SHA-1 is employed by the mobile device encryption processor 14. The keyed secure hash algorithm SHA-1 is well known and is not explained in detail here.

Details can be found in the following reference FIPS-180-2: Secure Hash Standard (SHS)-2002 available at http://csrc.nist.gov/.

The mobile device management apparatus 6 contains a management apparatus encryption processor 19, a management apparatus processor 20, a storage unit 22 and a management apparatus communication interface 24 comprising a receiver-transmitter capable of communication using radio frequencies with a mobile device 4.

The management apparatus processor 20 is adapted to control the management apparatus encryption processor 19, the storage unit 22 and the management apparatus communication interface 24. The management apparatus processor 20 is also adapted to communicate with any mobile device 4 via the management apparatus communication interface 24. The management apparatus processor 20 implements centralised mobile device management using the open mobile alliance device management (OMA-DM) specifications. OMA-DM sets up a data exchange between the mobile devices and the mobile device management apparatus 6 that allows remote configuration and management of the mobile devices. Details of the open mobile alliance device management can be found in the following references: SyncML Device Management Bootstrap OMA-SyncML-DM-Bootstrap-V1_{—}1_{—}2-20031209-A.pdf, SyncML Representation Protocol OMA-TS-SyncML-DataSyncRep-V1_{—}2-20060316-C.pdf, SyncML Data Sync Protocol OMA-TS-DS_Protocol-V1_{—}2-20060316-C.pdf, Device Management Conformance Requirements OMA-SyncML-DMConReqs-V1_{—}1_{—}2-20030613-A.pdf, SyncML Representation Protocol Device Management Usage OMA-SyncML-DMRepPro-V1_{—}1_{—}2-20030613-A.pdf, SyncML Device Management Standardized Objects OMA-SyncML-DMStdObj-V1_{—}1_{—}2-20031203-A.pdf and SyncML Device Management Tree and Description OMA-SyncML-DMTND-V1_{—}1_{—}2-20031202-A.pdf, all available at http://www.openmobilealliance.org.

The storage unit 22 comprises a hard disk drive 22 that contains upgrade software 28. The upgrade software comprises for example software programs that implement upgraded versions of a device operating software, a software patch destined to correct an error specific to one mobile device 4, new applications that were not originally included in initial versions of the mobile device 4, new functionalities or new services that have become available and can be implemented on the device 4. The upgrade software 28 is destined for an individual mobile device 4 amongst the plurality of mobile devices. For example, the upgrade software 28 destined to correct an error specific to one mobile device 4.

The management apparatus encryption processor 19 is adapted to implement a RSA private key encryption algorithm and to calculate a keyed secure hash algorithm SHA-1. In order to avoid piracy, the RSA private key is securely stored inside the mobile device management apparatus 6. In the current embodiment, the private key is securely stored inside the storage unit 22. In alternative embodiments, the private key is securely stored inside an electronic chip or a dongle.

FIG. 2 is a flow chart of a method 30 for securely upgrading a mobile device 4 belonging to a plurality of mobile devices with an individual upgrade software 28. The individual upgrade software 28 remains unusable by a mobile device 4 as long as the individual upgrade software has not been successfully identified and activated by the mobile device 4.

A mobile device 4 encrypts 32 its unique identification number using a RSA encryption algorithm and a public key and the mobile device 4 transmits 34 its encrypted unique identification number to the mobile device management apparatus 6. In the current embodiment this is achieved by including the encrypted device unique identification number in the data of the “DevInfo node” that is transmitted to the mobile device management apparatus 6 as part of an OMA-DM session. The encrypted unique identification number can be inserted into the “EXT” extension field available in the DevInfo node.

The encrypted unique identification number is decrypted 36 using a RSA algorithm and a private key known only to the mobile device management apparatus 6.

The mobile device management apparatus 6 calculates 38 a mobile device encryption identity from the individual upgrade software 28 and the unique identification number using a keyed SHA-1 hash function where the unique identification number is used as the key. The keyed SHA-1 hash function is applied to the individual upgrade software 28 in a binary format. In the current embodiment, the result of the keyed SHA-1 hash function is a sequence of 160 bits. The resulting mobile device encryption identity is a signature that is unique to an individual mobile device.

The mobile device management apparatus 6 then calculates 40 a management apparatus encryption identity from the mobile device encryption identity using an RSA encryption algorithm and a private encryption key known only to the mobile device management apparatus 6. The resulting management apparatus encryption identity is a secure signature that is unique to a mobile device.

The mobile device management apparatus 6 transmits 42 only the individual upgrade software 28 in binary format and the calculated management apparatus encryption identity over the air to the mobile device 4.

The mobile device 4 calculates 44 an activation encryption identity using the keyed SHA-1 hash function from the transmitted individual upgrade software 28 and its internal mobile device unique identification number present in its processor 8 which is used as the key for the keyed SHA-1 hash function.

The mobile device 4 calculates 46 an activation decryption identity from the transmitted management apparatus encryption identity using the RSA encryption algorithm and a public encryption key. The mobile device 4 compares 48 the calculated activation decryption identity to the activation encryption identity and activates 50 the individual upgrade software 28 for use by the mobile device 4 as a result of a positive comparison of the activation decryption identity to the activation encryption identity. The individual upgrade software 28 is activated by directing 52 the device processor 8 to a memory address of the storage unit 10 where the individual upgrade software 28 is stored the next time the mobile device is turn on. In the case of a negative comparison of the activation decryption identity to the activation encryption identity, the device processor 8 is directed 54 to a memory address of the storage unit 10 that contains the current device operation software. The Integrity of the upgraded software is checked at each boot of the mobile device 4 by executing method steps 44, 46, 48, 50 and 52 or 54.

In an alternative embodiment, the unique identification number of the mobile device 4 is not encrypted before transmission to the mobile device management apparatus 6.

The method 30 according to the invention permits the software of one targeted individual mobile device 4 to be selected amongst a plurality of mobile devices for upgrading and to be securely upgraded, the upgraded software being protected against external hacking and copying. The mobile device encryption identity is a signature that is unique to an individual mobile device and allows an individual upgrade software 28 to be transmitted over the air but only used by the intended and targeted mobile device 4. All other mobile devices will be prevented from using the individual upgrade software 28 as the use of their unique identification number to calculate the activation encryption identity will result in a mismatch with the activation decryption identity. The management apparatus encryption identity is a signature that is unique to a mobile device vendor or mobile device network operator thus permitting a plurality of mobile device vendors or mobile device network operators to securely use the method 30 according to the invention. In the case where a hacker copies the individual upgrade software 28 to their mobile device 4, the individual upgrade software 28 remains unusable as the hacker will be not have knowledge of the private key used to form the management apparatus encryption identity. Additionally, a hacker will not have knowledge of the encrypted unique identification number of the mobile device from which the individual upgrade software 28 was copied. Thus targeting of an individual mobile device with the upgrade software and adequate protection from hacking and copying of the upgrade software is simultaneously achieved.

1-7. (canceled)

8. A method for securely upgrading a mobile device belonging to a plurality of mobile devices with an individual upgrade software, the individual upgrade software remaining unusable by a mobile device as long as the individual upgrade software has not been activated;
providing each mobile device with a device processor containing a unique identification number individually identifying the mobile device from the other mobile devices, a device communication interface for communicating with a mobile device management apparatus, a storage unit containing current device operation software and destined to store the individual upgrade software that is communicated over the air by the mobile device management apparatus, a mobile device encryption processor for calculating an activation encryption identity and a decryption processor for calculating an activation decryption identity;
the mobile device management apparatus comprising a management apparatus processor, a management apparatus communication interface for communicating with a mobile device, and a management apparatus encryption processor for calculating a mobile device encryption identity and a management apparatus encryption identity;
wherein the method comprises for each mobile device:
transmitting its unique identification number to the mobile device management apparatus;
the mobile device management apparatus calculating a mobile device encryption identity from the individual upgrade software and the unique identification number using a keyed hash function; and a management apparatus encryption identity from the mobile device encryption identity using a private encryption key known only to the mobile device management apparatus;
transmitting only the individual upgrade software and the calculated management apparatus encryption identity over the air;
the mobile device calculating an activation encryption identity from the transmitted individual upgrade software and its internal mobile device unique identification number using a keyed hash function;
calculating an activation decryption identity from the transmitted management apparatus encryption identity;
comparing the calculated activation decryption identity to the activation encryption identity; and
activating the individual upgrade software for use by the mobile device as a result of a positive comparison of the activation decryption identity to the activation encryption identity.

9. The method according to claim 8, wherein the unique identification number of the mobile device is encrypted before transmission to the mobile device management apparatus; and the encrypted unique identification number is decrypted using a private key known only to the mobile device management apparatus before calculation of the first encryption identity.

10. The method according to claim 8, wherein the individual upgrade software is activated by directing the device processor to a memory address of the storage unit that contains the individual upgrade software following a positive comparison of the activation decryption identity to the activation encryption identity.

11. The method according to claim 8, wherein the device processor is directed to a memory address of the storage unit that contains the current device operation software following a negative comparison of the activation decryption identity to the activation encryption identity.

12. A system comprising a plurality of mobile devices and a mobile device management apparatus;
each mobile device comprising a device processor containing a unique identification number individually identifying the mobile device from the other mobile devices, a device communication interface for communicating with a mobile device management apparatus, a storage unit containing current device operation software and destined to store the individual upgrade software, a mobile device encryption processor for calculating an activation encryption identity and a decryption processor for calculating an activation decryption identity;
the mobile device management apparatus comprising a management apparatus processor, a management apparatus communication interface for communicating with a mobile device, and a management apparatus encryption processor for calculating a mobile device encryption identity and a management apparatus encryption identity;
wherein the device processor and the management apparatus processor are designed to put into practice a method for securely upgrading a mobile device belonging to a plurality of mobile devices with an individual upgrade software,
wherein the method comprises for each mobile device:
transmitting its unique identification number to the mobile device management apparatus;
the mobile device management apparatus calculating a mobile device encryption identity from the individual upgrade software and the unique identification number using a keyed hash function; and a management apparatus encryption identity from the mobile device encryption identity using a private encryption key known only to the mobile device management apparatus;
transmitting only the individual upgrade software and the calculated management apparatus encryption identity over the air;
the mobile device calculating an activation encryption identity from the transmitted individual upgrade software and its internal mobile device unique identification number using a keyed hash function;
calculating an activation decryption identity from the transmitted management apparatus encryption identity;
comparing the calculated activation decryption identity to the activation encryption identity; and
activating the individual upgrade software for use by the mobile device as a result of a positive comparison of the activation decryption identity to the activation encryption identity.

13. The system according to claim 12, wherein the unique identification number of the mobile device is encrypted before transmission to the mobile device management apparatus; and the encrypted unique identification number is decrypted using a private key known only to the mobile device management apparatus before calculation of the first encryption identity.

14. The system according to claim 12, wherein the individual upgrade software is activated by directing the device processor to a memory address of the storage unit that contains the individual upgrade software following a positive comparison of the activation decryption identity to the activation encryption identity.

15. The system according to claim 12, wherein the device processor is directed to a memory address of the storage unit that contains the current device operation software following a negative comparison of the activation decryption identity to the activation encryption identity.

16. A mobile device comprising a device processor containing a unique identification number individually identifying the mobile device from other mobile devices, a device communication interface for communicating with a mobile device management apparatus, a storage unit containing current device operation software and destined to store the individual upgrade software that is communicated over the air by the mobile device management apparatus, a mobile device encryption processor for calculating an activation encryption identity and a decryption processor for calculating an activation decryption identity;
wherein the device processor is designed to put into practice a method for securely upgrading a mobile device belonging to a plurality of mobile devices with an individual upgrade software,
wherein the method comprises for each mobile device:
transmitting its unique identification number to the mobile device management apparatus;
the mobile device management apparatus calculating a mobile device encryption identity from the individual upgrade software and the unique identification number using a keyed hash function; and a management apparatus encryption identity from the mobile device encryption identity using a private encryption key known only to the mobile device management apparatus;
transmitting only the individual upgrade software and the calculated management apparatus encryption identity over the air;
the mobile device calculating an activation encryption identity from the transmitted individual upgrade software and its internal mobile device unique identification number using a keyed hash function;
calculating an activation decryption identity from the transmitted management apparatus encryption identity;
comparing the calculated activation decryption identity to the activation encryption identity; and
activating the individual upgrade software for use by the mobile device as a result of a positive comparison of the activation decryption identity to the activation encryption identity.

17. The mobile device according to claim 16, wherein the unique identification number of the mobile device is encrypted before transmission to the mobile device management apparatus; and the encrypted unique identification number is decrypted using a private key known only to the mobile device management apparatus before calculation of the first encryption identity.

18. The mobile device according to claim 16, wherein the individual upgrade software is activated by directing the device processor to a memory address of the storage unit that contains the individual upgrade software following a positive comparison of the activation decryption identity to the activation encryption identity.

19. The mobile device according to claim 16, wherein the device processor is directed to a memory address of the storage unit that contains the current device operation software following a negative comparison of the activation decryption identity to the activation encryption identity.

20. A mobile device management apparatus comprising a management apparatus processor, a management apparatus communication interface for communicating with a mobile device and a management apparatus encryption processor for calculating a mobile device encryption identity and a management apparatus encryption identity;
wherein the management apparatus processor is designed to put into practice a method for securely upgrading a mobile device belonging to a plurality of mobile devices with an individual upgrade software,
wherein the method comprises for each mobile device:
transmitting its unique identification number to the mobile device management apparatus;
the mobile device management apparatus calculating a mobile device encryption identity from the individual upgrade software and the unique identification number using a keyed hash function; and a management apparatus encryption identity from the mobile device encryption identity using a private encryption key known only to the mobile device management apparatus;
transmitting only the individual upgrade software and the calculated management apparatus encryption identity over the air;
the mobile device calculating an activation encryption identity from the transmitted individual upgrade software and its internal mobile device unique identification number using a keyed hash function;
calculating an activation decryption identity from the transmitted management apparatus encryption identity;
comparing the calculated activation decryption identity to the activation encryption identity; and
activating the individual upgrade software for use by the mobile device as a result of a positive comparison of the activation decryption identity to the activation encryption identity.

21. The mobile device management apparatus according to claim 20, wherein the unique identification number of the mobile device is encrypted before transmission to the mobile device management apparatus; and the encrypted unique identification number is decrypted using a private key known only to the mobile device management apparatus before calculation of the first encryption identity.

22. The mobile device management apparatus according to claim 20, wherein the individual upgrade software is activated by directing the device processor to a memory address of the storage unit that contains the individual upgrade software following a positive comparison of the activation decryption identity to the activation encryption identity.

23. The mobile device management apparatus according to claim 20, wherein the device processor is directed to a memory address of the storage unit that contains the current device operation software following a negative comparison of the activation decryption identity to the activation encryption identity.

24. A method for securely upgrading a mobile device with an individual upgrade software, the individual upgrade software remaining unusable by a mobile device as long as the individual upgrade software has not been activated, comprising:
transmitting its unique identification number to a mobile device management apparatus;
calculating a mobile device encryption identity and a management apparatus encryption identity;
transmitting only the individual upgrade software and the calculated management apparatus encryption identity;
the mobile device calculating an activation encryption identity and an activation decryption identity;
comparing the calculated activation decryption identity to the activation encryption identity; and
activating the individual upgrade software for use by the mobile device as a result of a positive comparison.
